(19) United States
(12) Patent Application Publication
(10) Pub. No.: US 2013/0298000 A1
(43) Pub. Date: Nov. 7, 2013

(54) SOCIALLY RELEVANT CONTENT IN A NEWS DOMAIN

(71) Applicants: Scott ZUCCARINO, San Francisco, CA (US); Justin Lewis Kosslyn, New York City, NY (US); Richard Gingras, Los Altos, CA (US); Andre Rohe, Mountain View, CA (US); Vikas Sukla, Sunnyvale, CA (US); Erich Schmidt, Santa Clara, CA (US); Lucian Florin Cionca, Santa Clara, CA (US); Trevor Pering, San Francisco, CA (US); Michael Leotta, Santa Clara, CA (US)

(72) Inventors: Scott ZUCCARINO, San Francisco, CA (US); Justin Lewis Kosslyn, New York City, NY (US); Richard Gingras, Los Altos, CA (US); Andre Rohe, Mountain View, CA (US); Vikas Sukla, Sunnyvale, CA (US); Erich Schmidt, Santa Clara, CA (US); Lucian Florin Cionca, Santa Clara, CA (US); Trevor Pering, San Francisco, CA (US); Michael Leotta, Santa Clara, CA (US)

(21) Appl. No.: 13/761,106

(22) Filed: Feb. 6, 2013

Related U.S. Application Data
(60) Provisional application No. 61/641,845, filed on May 2, 2012.

(51) Int. Cl. G06F 17/22

(52) U.S. Cl. CPC G06F 17/2235
USPC 715/205

(57) ABSTRACT

The subject matter of this specification can be implemented in, among other things, a method for providing socially relevant content in a news domain. The methods includes a steop for receiving a request from a user for a news aggregator page related to a news story. The method also includes a step for retrieving social contents items related to the news story. The method also includes a step for providing the news aggregator page for display, wherein the news aggregator page includes multiple links to news content items related to the news story, and the retrieved social content items related to the news story.

### CROSS-REFERENCES TO RELATED APPLICATIONS

The present application claims the benefit of priority from U.S. Provisional Patent Application Ser. No. 61/641,845, entitled, “SOCIALLY RELEVANT CONTENT IN A NEWS DOMAIN,” filed on May 2, 2012 which is hereby incorporated by reference in its entirety for all purposes.

### BACKGROUND

This instant specification relates to news aggregator pages, in particular to social content on news aggregator pages.

People may browse the world-wide-web for news, provided by news aggregators that capture news from multiple news sources. A user browsing a news aggregator page may drill down into a particular story of interest to get more information or related content about that story.

### SUMMARY

In one aspect, the disclosed subject matter relates to a method for providing news aggregator pages. The method includes receiving a request from a user for a news aggregator page related to a news story. The method also includes retrieving social content items related to the new story. Social content items may include comments, images, videos, audios, etc. The method also includes providing the news aggregator page for display, wherein the news aggregator page comprises a plurality of links to news content items related to the news story, and the retrieved social content items related to the news story. Other aspects can include corresponding systems, apparatus and computer program products.

These and other aspects can provide one or more of the following features. Social content items may include links to social content items. Social content items may be retrieved by searching comments provided by users of a social networking platform to determine if the comments are relevant to the new story, e.g., by searching for keywords related to the news story in the comments. Retrieved comments may be filtered by when the comments were received, or by a source of the comments (e.g., where the source is a member of the requesting user's social network groups, or where the source is a news professional commenting on the news story, or where the source is a professional organization associated with the new story), or by a total number of comments that may be provided in the news aggregator page.

In another aspect, the disclosed subject matter further relates to a non-transitory computer-readable medium. The computer-readable medium includes instructions that, when executed by a computer, cause the computer to implement a method for providing social content in a news aggregator page. The instructions include code for receiving a request for an anchor story page related to a news story. The instructions also include code for searching comments provided in a social networking platform to determine if the comments are relevant to the news story. The instructions also include code for retrieving social content based on the comments determined to be relevant to the news story. The instructions also include code for providing the anchor story page for display, wherein the anchor story page comprises a plurality of links to news content items related to the news story, and at least a portion of the retrieved social content based on the comments determined to be relevant to the news story. Other aspects can include corresponding systems, apparatus and methods.

These and other aspects can provide one or more of the following features. Comments found to be relevant to the news story may be filtered and social content may be retrieved based on the filtered comments. Social content may include images, links to social content items, audio, video, album of images, etc., associated with the comments.

The disclosed subject matter further relates to a system. The system includes one or more processors and a memory storing instructions which, when executed by the one or more processors cause the one or more processors to provide social content in an aggregated content page. The instructions include code to receive a request from a user for an aggregated content page related to a topic of interest. The instructions also include code to retrieve comments related to the topic of interest from a social networking platform. The instructions also include code to provide the aggregated content page for display, wherein the aggregated content page includes a plurality of content items related to the topic of interest, and at least a portion of the retrieved comments related to the topic of interest. Other aspects can include corresponding methods, apparatus and computer program products.

These and other aspects can provide one or more of the following features. Social content may be retrieved that is associated with retrieved comments related to the topic of interest, and the retrieved social content may be provided for display in the aggregated content page. Comments may be retrieved by searching for comments on social networking platforms, e.g., by searching for keywords related to the topic of interest in the comments. Comments found to be related to the topic of interest may be filtered (e.g., by source, by time of receipt, or by the number of comments) before providing the filtered comments for inclusion in an aggregated content page.

These and other embodiments may provide one or more of the following advantages. One advantage is that viewers browsing aggregator news pages may have a more enhanced experience about the news topic of interest to them. The enhanced experience is provided by the reader getting a context around the story by having a sense of the conversations happening around a story. A reader may get the insight of their friends about the particular topic of the anchor story. The reader may get insight from journalists covering a particular news story (e.g., comments journalists may be making without their official voice). Additionally, comments from professional organizations associated with the story may be of interest to see what parties with a higher or a more direct stake in the story are saying. Looking at it another way, the advantage is that by providing social content associated with a story on a news aggregator page, new news pipelines are being leveraged for building the story (i.e., the new news pipelines being comments from various parties of interest as discussed here).

It is understood that other configurations of the subject technology will become readily apparent from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### DESCRIPTION OF DRAWINGS

FIG. 1 illustrates an example of a computer system configured to provide social content in news aggregator pages.

FIG. 2A illustrates a schematic of an example news aggregator page.

FIG. 2B illustrates an example of a news aggregator page.

FIG. 3 illustrates an example of the server and data repository of FIG. 2 in more detail.

FIG. 4 is a flow chart that shows an example of a process for providing social content in news aggregator pages.

FIG. 5 is a flow chart that shows another example of a process for providing social content in news aggregator pages.

FIG. 6 conceptually illustrates an example electronic system with which some implementations of the subject technology are implemented.

### DETAILED DESCRIPTION

This document describes systems and techniques for providing social content in aggregated content pages or aggregated streams of content. For example, the subject technology may provide social content in a news aggregator page, which is a news page that provides news content from multiple sources. News sources may include websites of newspapers, online magazines, other electronic news sources, etc. In various aspects, a news aggregator page is supplemented with one or more sections containing social content, e.g., commentaries from various social sites, comments on news items on social networking platforms or blogs. For the purposes of this disclosure, a main news aggregator page is a news aggregator page containing news items for multiple news stories, while an anchor story page is a news aggregator page containing news items related to a particular story of interest to a user—an anchor story.

An anchor story page may include a first section that contains information about an anchor story being covered in the anchor story page, and multiple related content sections. Related content sections include other news sections that provide other news content related to the anchor story. For example, other news sections may provide news content broken down by categories. The categories may include secondary articles' information, news content for a particular geographic location, or news content containing an in-depth analysis for the anchor story. News content items may include summaries/excerpts/abstracts from news content, links to news articles or other news items, or text, image, audio, or video content.

In various aspects, the anchor story page is supplemented with one or more related content sections that contain social content items, e.g., comments provided by a user's social groups, or by news organizations or professional organizations related to the anchor story. Social content items may include commentary provided in a social networking platform or in blogs related to the selected story of interest. Social content may also include text, image, audio or video content associated with social commentaries related to the story of interest or to one or more related news content items.

In some aspects, an anchor story page is delivered containing multiple sections containing news content items and social content items, where the content is related to a selected news story of interest or anchor story. The anchor story page may be provided for display on a client device upon a request for an anchor story page, for example, by a user selecting a news story of interest from a main news aggregator page. For example, a user may click on an article link provided on the main news aggregator page to request an anchor story page. An anchor story page may be requested by other means (e.g., typing in a URL for a news anchor page, clicking on a link from any other webpage having a link to the anchor story page, etc.).

In various aspects, social content to be delivered for a selected anchor story page is retrieved by searching content in a social networking platform. The content that may be searched includes comments, posts, and other text, audio, video or image data provided in relation to a particular news item or news story of interest. In some implementations, comments accessible in a social networking platform are searched to determine if they are relevant to the selected anchor story page. Comments may be searched for keywords or synonyms to keywords that are related to the anchor story to determine if they are relevant for the selected anchor story page.

Comments found to be relevant to a requested anchor story page may be filtered prior to delivering for display in an anchor story page. Comments may be filtered by the source of the comment, by the time that the comment was received at, or by the sections in which the comments will be displayed in the anchor story page.

In various aspects, comments found to be relevant to a requested anchor story may be used to retrieve additional social content (e.g., text, image, audio or video content) associated with the comments for display in the anchor story page. In various other aspects, social content provided in an anchor story aggregator page may be periodically updated to provide recent social commentary related to the anchor story being covered in the anchor story page.

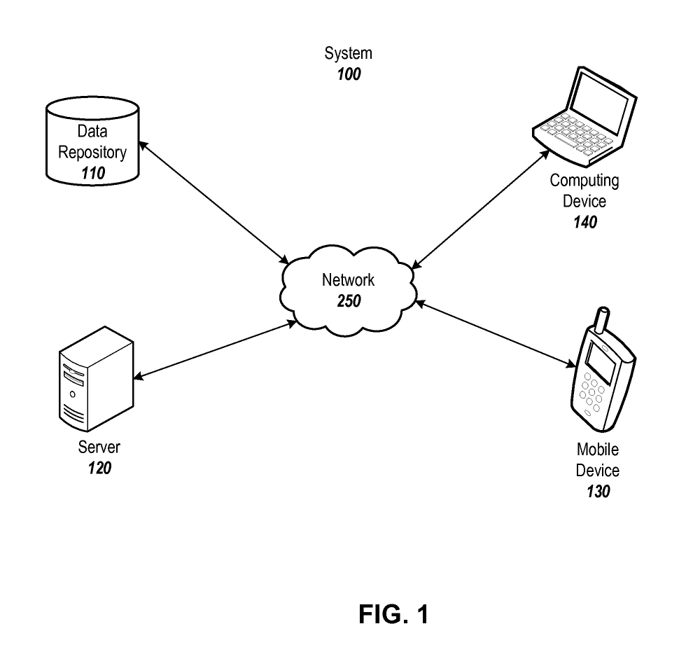

FIG. 1 illustrates an example of a computer system 100 configured to provide social content items for news aggregator pages. As shown, the computer system 100 includes a data repository 110, a server 120, a mobile device 130 and a computing device 140. Data repository 110 may be, e.g., a relational database, an object-oriented database, a web application server, a file, or any other data storage that can maintain and provide data about news and social content for news aggregator systems. The data repository 110, the server 120, the mobile device 130, and the computing device 140 may be configured to communicate with one another via a network 150. The network 150 may include the Internet, an intranet, a local area network, a wide area network, a wired network, a wireless network, a cellular network, a WiFi network, or a virtual private network (VPN).

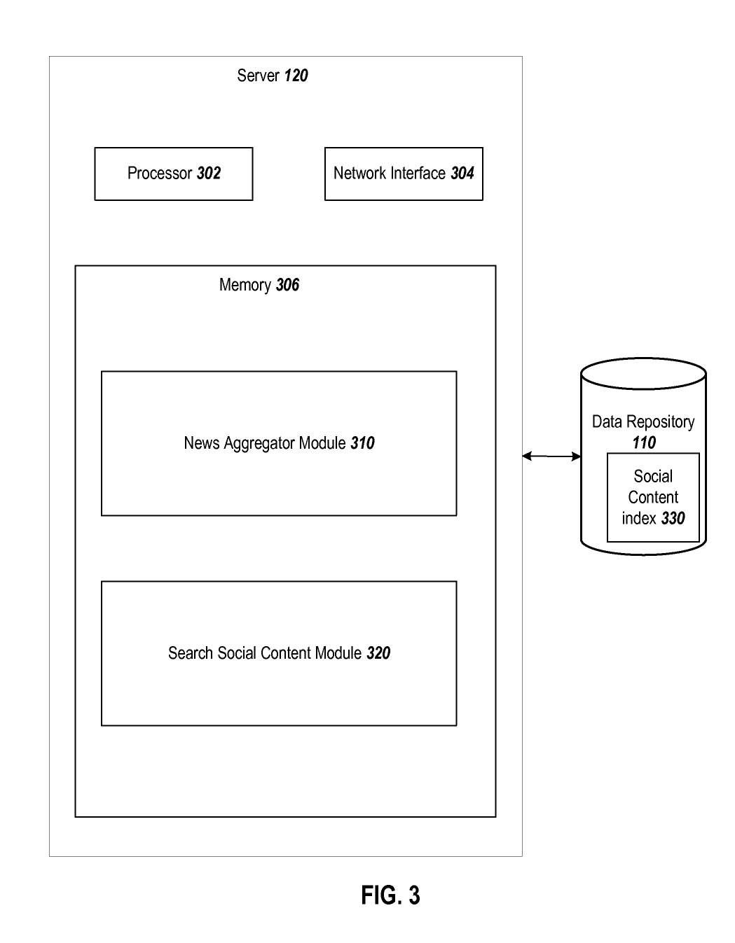

The data repository 110 may store data (e.g., text, images, videos, audio files, news updates, social comments, posts, blog entries, links to news items for social comments, social networks, links to news articles for an anchor story, other social content, e.g., images, audio or videos associated with news stories, etc.) related to a system for providing social content in news aggregator pages. Data repository 110 may also maintain multiple data indexes as appropriate for searching for various types of data, e.g., a news index for searching for news content items and a social content index for searching for social content items related to an anchor story. The indexes may be built or maintained by the data repository (e.g., the database), the server, or other systems not depicted in FIG. 1. The database may include a single machine, multiple machines, a single processor system, or a multi-processor system. One example of the data repository 110 is described in more detail in conjunction with FIG. 3 below.

The server 120 may include modules for providing social content items in news aggregator pages by searching the data repository 110 or other sources. The server 120 may be implemented as a single machine with a single processor, a multi-processor machine, or a server farm including multiple machines with multiple processors. One example of the server 120 is described in more detail in conjunction with FIG. 3 below.

The mobile device 130 may be a mobile phone, a personal digital assistant (PDA), a tablet computer, a netbook, or a laptop computer. The mobile device 130 may be portable and may be carried by a user, for example, in a pocket, a purse, a backpack, or a briefcase. The mobile device 130 may also include a mobile browser or a mobile application configured to request for news aggregator pages (e.g., a main news aggregator page or an anchor story page) and news updates to news aggregator pages from server 120, to display news pages and updates, and to request for news updates from server 120. While only one mobile device 130 is illustrated in FIG. 1, the subject technology may be implemented in conjunction with one or more mobile devices 130.

The computing device 140 may be a laptop computer, a desktop computer, a mobile phone, a personal digital assistant (PDA), a tablet computer, a netbook, a television with one or more processors embedded therein or coupled thereto, a physical machine, or a virtual machine. The computing device 140 may include one or more of a keyboard, a mouse, a display, or a touch screen. The computing device 140 may also include a web browser or an application configured to request for news aggregator pages (e.g., a main news aggregator page or an anchor story page) and news updates to news pages from server 120, to display news pages and updates, and to request for news updates from server 120.

A user of the computing device 140 or mobile device 130 may access the browser or the application on the respective device to receive news aggregator pages for display to the user (e.g. a web page of aggregated news from multiple sources). A news aggregator page may contain social content items, in addition to links and other content about news items. A news aggregator page may also be updated with new news items or new social content items upon periodically checking for news updates (e.g., the browser or application may have a code module that periodically checks for news updates).

While each of the data repository 110, the server 120, the mobile device 130, and the computing device 140 are illustrated in FIG. 1 as separate machines, in example aspects, one or more of the databases 110, the server 120, the mobile device 130, and the computing device 140 may be implemented as a single machine. For example, the functions of the data repository 110 and the server 120 may be implemented within a single machine.

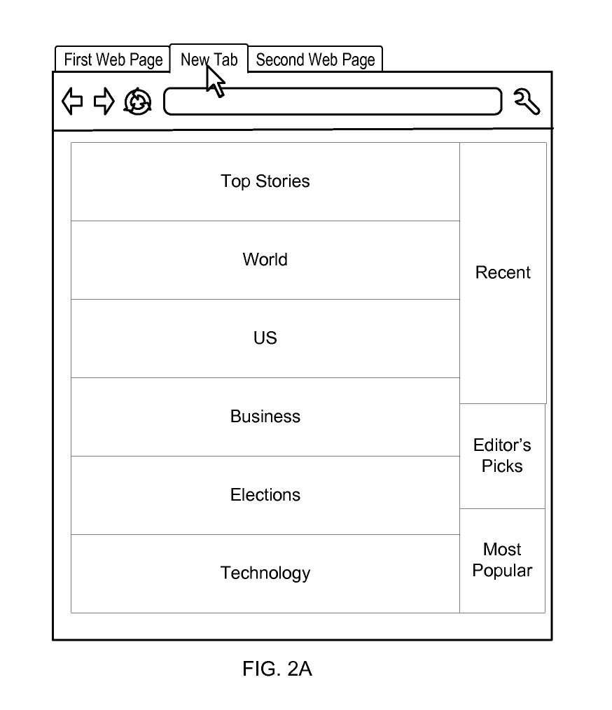

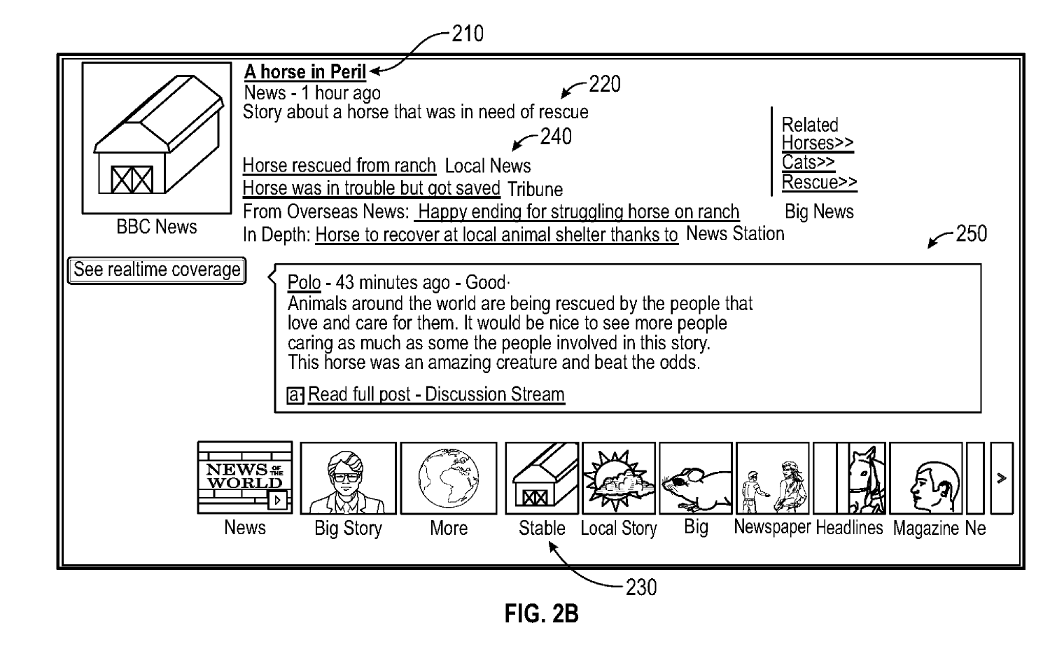

FIG. 2A illustrates a schematic of an example news aggregator page. FIG. 2A shows a section for stories belonging to news sections for top stories, world, US, business, elections, and technology news in the center portion of the news aggregator page. In addition, FIG. 2A shows several other related news content sections on the right portion of the page (a recent, editor's picks, and a most popular section). Each section may contain links to news articles, abstracts, audios, videos, images, etc. about the stories provided in any particular section. The page layout of a news aggregator page illustrated in FIG. 2A is one example and a variety of webpage or application display layouts that capture the concept of a main news aggregator page without deviating from the scope of this disclosure is possible.

FIG. 2B depicts an anchor story page containing various sections for related news content and one section containing related social content. Title 210 of the anchor story page is “A horse in peril”. Below the title, abstract 220 contains an overview of the anchor story, stating “Story about a horse that was in need . . . ”. Together, the title 210 and the abstract 220 of FIG. 2B depict a first section relating to the anchor story. On the bottom portion of FIG. 2B, other related news content items 230 are provided. Other related news content items 230 contain various images with section headings of “News”, “Big Story”, “More”, “Stable”, “Local Story”, “Big”, “Newspaper”, “Headlines”, “Magazine”, etc. to access other related news items about the anchor story.

FIG. 2B contains various other related news content sections. Related news section 240 contains a link to “Horse rescued from ranch” local news article and another link to “Horse was in trouble but got saved” article. Related news section 240 also has related news content for “From Overseas News” which has one link to a “Happy ending for struggling horse on ranch” and for “In Depth” news which has one link to “Horse to recover at local animal shelter thanks to” article. Although FIG. 2B's related news section 240 contain a description of the content type and a link to one article, other content may be provided in those sections. For example related news content may include multiple news articles' links, abstracts/excerpts/summaries, audio, video, image, or text data related to new items.

FIG. 2B also contains a related social content section 250. The related social content section 250 depicted has commentary from “Polo” provided at “43 minutes ago” and contains an abstract of the commentary provided “Animals around the world . . . beat the odds.” The related social content section 250 also contains a link to “Read full post—Discussion Stream” for more details on the social content shown on the page. The comments illustrated in the related social content section 250 of FIG. 2B may have been retrieved from a social networking platform, on which a user provided the comment about the “A horse in peril” story. Related social content sections in anchor story pages may include other links, comments, abstracts, audio, video, image, or text data.

The page layout illustrated in FIG. 2B is one example and a variety of webpage or application display layouts that capture the concept of an anchor story page containing social content items without deviating from the scope of this disclosure. For example, the content of the sections of a news aggregator page may be interspersed without deviating from the scope of this disclosure. Social content may be provided per related news content section or may be provided for the entire page or in some combination thereof. An anchor story page may include any number of related content sections for news or social content. The details or the number of content items provided within any sections may vary from the example provided in FIG. 2B.

FIG. 3 illustrates an example of the server and database of FIG. 1 in more detail. As shown, the server 120 includes a processor 302, a network interface 304, and a memory 306. The processor 302 is configured to execute computer instructions that are stored in a computer-readable medium, for example, the memory 306. The processor 302 may be a central processing unit (CPU). While only one processor 302 is illustrated, the server 220 may include multiple processors. Furthermore, while the server 120 is illustrated as a single machine, the server 120 may include multiple machines, or portions of computing power available on the cloud. The network interface 304 is configured to allow the server 120 to transmit and receive data in a network, e.g., network 150 of FIG. 1. The network interface 304 may include one or more network interface cards (NICs). The memory 306 may store data or instructions. As illustrated, the memory 306 includes a news aggregator module 310 and a search social content module 320. FIG. 3 also shows a data repository 110 of FIG. 1 having searchable social content index 330.

The news aggregator module 310 may be configured to facilitate receiving, from a computing device (e.g., computing device 140 or mobile device 130), a request for a news aggregator page. The news aggregator page requested may be a main news aggregator page, containing multiple news stories, or an anchor story page, containing multiple sections of related content for an anchor story of interest to the user. The request for an anchor story page may provide with it a news story identifier, to indicate which story is of interest to a user (or an anchor story identifier) or a user identifier to indicate the requesting user's identity in a social networking platform. News aggregator module 310 may be configured to provide a news aggregator page for display at the requesting client computing device or mobile device. News aggregator module 310 may be configured to provide social content items to a client device for updating social content in a news aggregator page.

A provided anchor story page may contain multiple sections containing news content items and social content items related to the provided news story identifier. News aggregator module 310 may provide instructions for how to display content for the news aggregator or anchor story pages, in addition to providing the content itself. News aggregator module 310 may be configured to communicate with search social content module 320 in order to provide social content for a requested anchor story page.

In some implementations, news aggregator module 310 is a web server application that handles HTTP GET requests for a news aggregator page (e.g., from a web browser application on a client computing device 140 or mobile device 130) and replies to the requests with an HTML page containing the news and social content items and details for displaying the requested news aggregator page. The HTTP GET request for a news aggregator page, for example, when the requested page is an anchor story page, may provide a news story identifier (e.g., to use to retrieve social content related to the news story specified).

The GET request may also provide a user identifier to indicate the requesting user's identity in a social networking platform. In some implementations, a user's identity may be ascertained from another application running on the client computing device (e.g., the user is logged into the social networking platform and thus the identity may be determined based on that) or via some other indirect source for determining user identity. The user's identity may be used, upon user authorization, to determine members of the user's social networks in a social networking platform for filtering comments. The provided HTML page may have sections that display news content items and sections that display social content items related to the provided news story identifier. The HTML page for a news aggregator page may also include JavaScript or other code for periodically updating news or social content items related to a news story.

The web server application, HTML/JavaScript news aggregator pages, HTTP GET requests implementation described above is one example implementation. There may be a host of languages, server technologies, client technologies, middle-tier technologies, system, cloud-based systems, web services, and system and application designs that can be used instead of the described implementation without deviating from the scope of this disclosure.

The search social content module 320 may be configured to search and retrieve social content items to be provided for display in news aggregator pages. Search social content module 320 may be configured to communicate with news aggregator module 310 to provide social content for inclusion in a news aggregator page. The search social content module 320 may search for social content related to a news aggregator page by searching a data repository 110. The searching for social content may be performed by searching various indexes built and maintained for a database (e.g., database that may house data for a social networking platform and maintain various search indexes to facilitate searching commentaries provided in the social networking platform).

In various aspects, search social content module 320 retrieves social content to be delivered for anchor story pages by searching comments provided by users of a social networking platform related to the news story. Comments include comments, posts, and other textual or other forms of data provided as commentary on a particular news item or news story of interest. Social networking platforms include social networking sites, blogs, etc.

Search social content module 320 may be configured to communicate with a data repository 110 (e.g., using social content index 330) to search for social content related to a news story for inclusion on an anchor story page. In some aspects, search content module 320 will search for keywords or synonyms to keywords, that are related to a requested anchor story, by using the social content index 330 to determine which comments are relevant to the requested anchor story page.

Keywords or synonyms to keywords to use for searching for social content may be based on a list of terms associated with one or more documents or stories of the anchor story page. In some aspects, each anchor story page is associated with a cluster of documents (e.g., one or more articles or other documents that relate to the main topic of the anchor story). The cluster of documents may be associated with a vector of “rare terms” that capture some of the key topics for each document in the cluster. In some aspects, keywords or synonyms to keywords to use for searching for related social content may be based on an aggregation of the vectors of “rare terms” (sometimes referred to as a centroid vector) maintained for the cluster of documents for an anchor story page. In some aspects, a set of “rare terms” determined from the multiple vectors for the cluster of documents is used for topic extraction to narrow down the terms to use for searching for social content. For example, a set of terms found in the “rare terms” in the vectors for the cluster of documents may be used to analyze the text of the documents to determine what terms express the topic of the anchor story page. In some aspects, these a set of keywords that are determined to be associated with the anchor story page are used for title support, e.g., determine if the title of the various cluster of documents contains one or more of the keywords. A set of keywords may then be used to query for social content.

For example, keywords that surface in a certain percent of the vectors may be used as the keywords to search for related social content. The keywords determined from the aggregation of the vectors may be further refined by analyzing the text of the documents to determine if the terms express the concept or topic of the documents. The keywords determined by topic extraction may be further refined by title. For example, where the keywords determined from the aggregation of the vectors also exist in the title of the cluster of documents, then those keywords may be selected for querying for related social content (e.g., using the social content index 330). In some aspects, a set of keywords maintained for the cluster of documents of an anchor story page are used to query for related social content.

Social content index 330 may be maintained and updated by searching for updates to social content (e.g., by searching one or more social commentary data repositories accessible to the system). Social index 330 may be a relational database index that helps search for social content available for a news story. Social content index 330 may be built and maintained in a host of ways without deviating from the scope of this disclosure, so long as it allows for searching of related social content to provide in news aggregator pages. Social content index 330 is provided as an example of one implementation for searching for social content. Search social content module 320 may search for social content related to the anchor story by using any other search mechanism without deviating from the scope of this disclosure. Social content will be provided based on who is authorized to view the social content. In some implementations, the system may provide users an option to opt in or opt out of providing their social content in aggregated streams or pages or having the social content indexed.

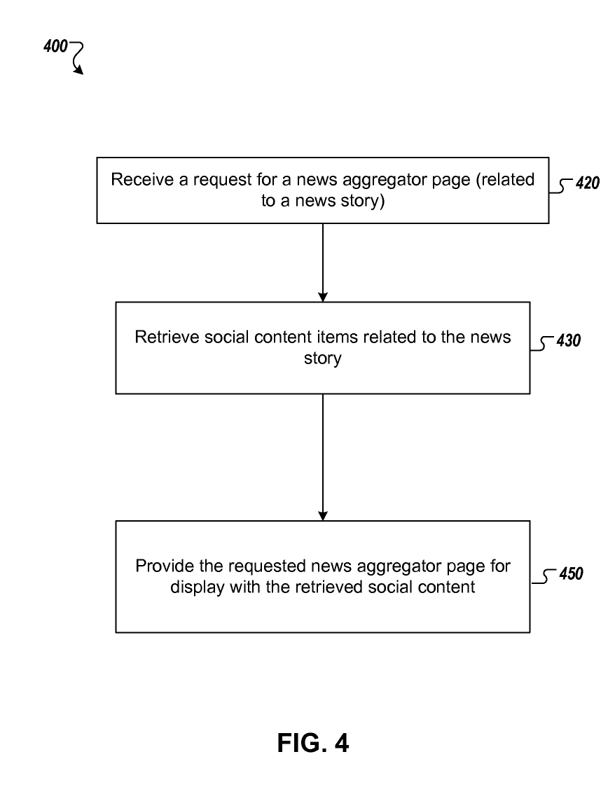

FIG. 4 is a flow chart that shows an example of a process for providing social content in news aggregator pages. The process may render a news aggregator page as described for FIG. 2A or FIG. 2B. The process may be performed, for example, by a system as described in FIG. 1 or 3. For clarity of presentation, the description that follows uses the news aggregator pages as described for FIGS. 2A and 2B and systems as described in FIGS. 1 and 3 as examples for describing the process. However, other news aggregator page layouts and other systems, or combination of systems, may be used to perform the process.

Process 400 starts when a request for a news aggregator page is initiated. It may start for example, by a user of a client computing device providing a URL for a news aggregator page or by a user selecting a news story of interest from a main news aggregator page (e.g., as described for FIG. 2A). In step 420, a server system receives a request for a news aggregator page. The received request may be for a news aggregator page for a news story of interest, an anchor story page. Step 420 may be handled by the news aggregator module 310 of FIG. 3. A received request may include a news story identifier, to help in retrieving social content for the requested news aggregator page. The request may also include a user identifier to be used to search for social content in a social networking platform to provide with the requested news aggregator page.

In step 430, process 400 retrieves authorized social content items related to the news story. Step 430 may be performed by the search social content module 320 of FIG. 3 and the search social content module 320 may provide the retrieved social content items to news aggregator module 310. Social content items related to the news story may be found by searching an index, e.g., a social content index 330 in FIG. 3. The retrieved social content may be retrieved by searching social networking platforms, blogs, micro-blogs, etc. for social content relevant to the news story. Social content may be searched for relevancy by searching for keywords or synonyms of keywords related to the news story. The retrieved social content includes comments, posts, blog entries, other text, image, audio, or video data associated with social commentaries.

In step 450, the server system provides the requested news aggregator page for display, providing with it the retrieved social content from step 430. Step 450 may be performed by news aggregator module 310 of FIG. 3, resulting in an anchor story page as illustrated in FIG. 2B. The anchor story page may contain multiple sections for news content items and social content items related to the requested story of interest as illustrated in FIG. 2B. The provided news aggregator page may be a combination of HTML and JavaScript, providing news content items and social content items and the instructions on how to display both of the related content items on the news aggregator page (see discussion above about news aggregator module 310 for more details).

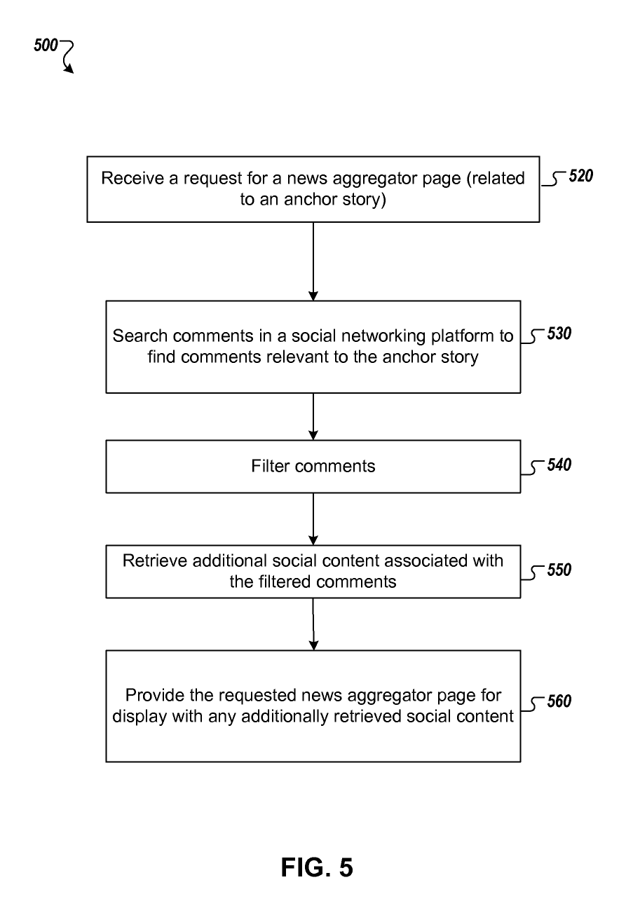

FIG. 5 is a flowchart that illustrates another example for providing social content in news aggregator pages. Process 500 illustrates searching for relevant social content based on searching comments of a social networking platform. Process 500 starts similarly to how process 400 starts, at the request of an anchor story page. Step 520 is similar to step 420 of process 400, a server component receives the request for the anchor story page. (See above description for step 420 of process 400 in FIG. 4 for more details). In step 530, process 500 searches comments in a social networking platform to find comments relevant to the requested anchor story of step 520. Comments may be determined to be relevant by searching for keywords or synonyms to keywords, that are related to the anchor story, in the text of the comments.

The step 530 search may use a social content index 330 as described for FIG. 3 to find comments relevant to the anchor story page. The search may be performed by searching social content index 330 by looking for keywords or synonyms related to the anchor story. Comments found to be relevant to the requested anchor story may be used to retrieve additional social content (e.g., image, audio, or video data) associated with those comments prior to delivering the social content for display in the anchor story page.

At step 540 comments determined to be relevant at step 530 may be filtered prior to providing social content for display in the requested anchor story page. In various aspects, comments are filtered by the source of the comment (e.g., the author or the social network or entity that provided the comment). In some aspects, comments may be filtered by those comments that are provided by members of one or more social groups accessible to the user who selected the news story of interest (e.g., by using a provided user identifier with the request for the news aggregator page at step 520). Filtering comments made by members of the user's social groups of the requesting user allows the requesting user to get a sense of the story as discussed, e.g., by her friends or family or other social groups that the use belongs to.

In some aspects, comments may be filtered by those comments provided by certain entities (e.g., represented as a social group on a social networking platform) or members of the entities, for example, a news organization or a professional organization that is commenting on the anchor story. For example a selected anchor story page may be covering a breaking news story about the death of the CEO of a major company, and that story may be covered by various journalists, and comments made by one or more of those various journalists may be provided in a related social content section of the anchor story page (e.g., to provide the un-official voice of the journalists about the anchor story). As another example, the anchor story may be about an event at a university and representatives of the university may be commenting on the subject of the anchor story and such commentaries may be displayed in another related content section of the anchor story page (e.g., to provide comments by parties that have a higher stake in the anchor story coverage).

In some implementations, comments found to be relevant to a requested anchor story page may be filtered by the time that the comments were received for delivering for display in the requested anchor story page. For example, only comments provided within a last certain time frame/interval (e.g., number of hours, number of days, etc.) may be selected. Filtering comments by time may have the advantage of providing recent commentary that may be more relevant to the anchor story. As another example, only the last five comments may be retrieved for display due to space limitations in the page where they will be displayed.

In yet other aspects, comments found to be relevant to a requested anchor story page may be filtered by one or more related content sections in which the comments will be displayed. For example, comments may be filtered by a user's social groups for a related content section that displays comments by, for example, the user's friends or family. In another example, comments may be filtered by either news organizations or professional organizations to display the comments in a respective related content section designed to display comments provided by news organizations covering the anchor story or professional organizations with a stake in the anchor story. The type of content to be provided in one or more related content sections (for social content or otherwise) may be provided in the request of the anchor story page. In some implementations, the server system handling the request for the anchor story or news aggregator page received at step 520, may have knowledge of the content types in the various related content sections of the requested news aggregator page.

At step 550, social content associated with the filtered comments is retrieved. In some aspects, the searched comments themselves are the social content that is delivered in the anchor story page, thus precluding any need to retrieve any other social content associated with the comments. The comments themselves may be the social content retrieved or it may be other social content associated with the comments (e.g., text, audio, video, image, or other links provided with the comments) that is retrieved. The social content retrieved at step 550 may be provided for inclusion in the requested news aggregator page as described in step 560 of FIG. 5.

Processes 400 and 500 of FIGS. 4 and 5 are example processes for providing social content in anchor story pages. A host of variations to the steps illustrated in processes 400 and 500 may be implemented without deviating from the scope of this disclosure. The steps of processes 400 and 500 may either be performed sequentially or simultaneously or partially sequentially and partially simultaneously without deviating from the scope of this disclosure. The steps may be performed in the order illustrated or in any other order or combination.

The examples above describe integrating social content in news aggregator pages. However, the systems and methods described herein may be used for integrating social content into other types of aggregated content pages or streams. For example, content may be aggregated based on any topic of interest. The topic of interest may be based on an official/formal news story, as discussed above with respect to news aggregator pages, or on a popular trending blog post, posted video, posted image, or other content item. As such, comments and other social content related to a late-breaking discussion on any topic of interest may be integrated in a page or stream of aggregated content related to the topic of interest.

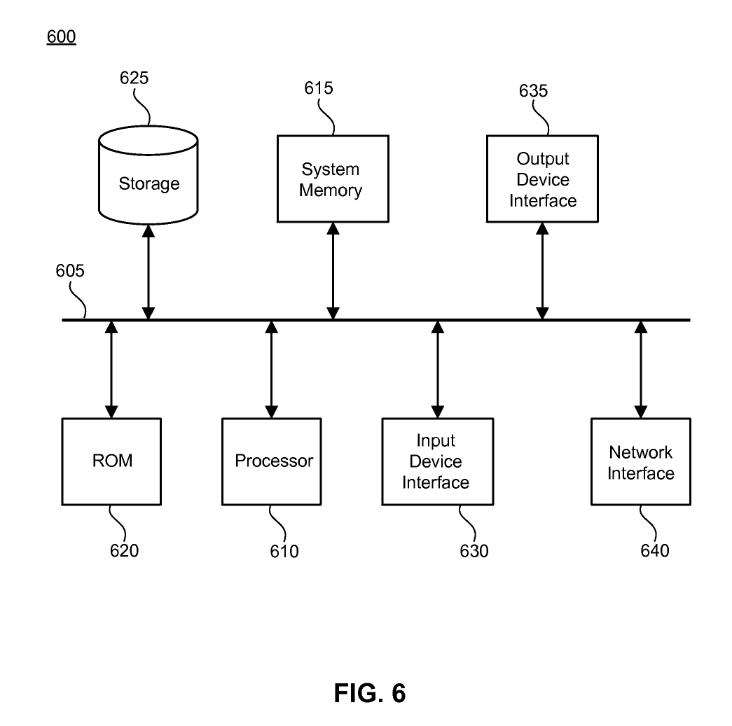

FIG. 6 conceptually illustrates an electronic system 600 with which some implementations of the subject technology are implemented. For example, one or more of the data repository 110, the server 120, mobile device 130, or the client computing device 140 of FIG. 1 may be implemented using the arrangement of the electronic system 600. The electronic system 600 can be a computer (e.g., a mobile phone, PDA), or any other sort of electronic device. Such an electronic system includes various types of computer readable media and interfaces for various other types of computer readable media. Electronic system 600 includes a bus 605, processing unit(s) 610, a system memory 615, a read-only memory 620, a permanent storage device 625, an input device interface 630, an output device interface 635, and a network interface 640.

The bus 605 collectively represents all system, peripheral, and chipset buses that communicatively connect the numerous internal devices of the electronic system 600. For instance, the bus 605 communicatively connects the processing unit(s) 610 with the read-only memory 620, the system memory 615, and the permanent storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some implementations of the subject technology use a mass-storage device (for example a magnetic or optical disk and its corresponding disk drive) as the permanent storage device 625.

Other implementations use a removable storage device (for example a floppy disk, flash drive, and its corresponding disk drive) as the permanent storage device 625. Like the permanent storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the processes of the subject technology are stored in the system memory 615, the permanent storage device 625, or the read-only memory 620. For example, the various memory units include instructions for providing socially relevant content in news domains in accordance with some implementations. From these various memory units, the processing unit(s) 610 retrieves instructions to execute and data to process in order to execute the processes of some implementations.

The bus 605 also connects to the input and output device interfaces 630 and 635. The input device interface 630 enables the user to communicate information and select commands to the electronic system. Input devices used with input device interface 630 include, for example, alphanumeric keyboards and pointing devices (also called “cursor control devices”). Output device interfaces 635 enables, for example, the display of images generated by the electronic system 600. Output devices used with output device interface 635 include, for example, printers and display devices, for example cathode ray tubes (CRT) or liquid crystal displays (LCD). Some implementations include devices for example a touchscreen that functions as both input and output devices.

Finally, as shown in FIG. 6, bus 605 also couples electronic system 600 to a network (not shown) through a network interface 640. In this manner, the electronic system 600 can be a part of a network of computers (for example a local area network (“LAN”), a wide area network (“WAN”), or an Intranet, or a network of networks, for example the Internet. Any or all components of electronic system 600 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

The detailed description set forth is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may not be required and may not be executed. Some of the steps may be performed in an order different than illustrated. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

What is claimed is:

1. A computer-implemented method comprising:
receiving a request from a user for a news aggregator page related to a news story;
retrieving social contents items related to the news story; and
providing the news aggregator page for display, wherein the news aggregator page comprises a plurality of links to news content items related to the news story, and the retrieved social content items related to the news story.

2. The computer-implemented method of claim 1, wherein the social content items comprise links to social content items.

3. The computer-implemented method of claim 1, wherein retrieving social content items related to the news story comprises:
searching comments provided by users of a social networking platform to determine if the comments are relevant to the news story.

4. The computer-implemented method of claim 3, wherein searching comments provided by the users of the social networking platform to determine if they are relevant to the news story comprises searching for one or more keywords in the comments provided by the users of the social networking platform, wherein the one or more keywords are related to the news story.

5. The computer-implemented method of claim 3, further comprising:
filtering the comments determined to be relevant to the news story.

6. The computer-implemented method of claim 3, wherein the filtering is done by filtering the comments by when the comments were received.

7. The computer-implemented method of claim 3, wherein the filtering is done by filtering the comments for a specified number of most recently received comments relevant to the news story.

8. The computer-implemented method of claim 3, wherein the filtering is done by filtering the comments by a source of the comments.

9. The computer-implemented method of claim 8, wherein the source is a member of the user's social networking groups.

10. The computer-implemented method of claim 8, wherein the source is a news professional commenting on the news story.

11. The computer-implemented method of claim 8, wherein the source is a representative of a professional organization associated with the news story.

12. A computer-readable medium storing instructions that when executed cause a computer to perform operations, the operations comprising:
receiving a request for an anchor story page related to a news story;
searching comments provided in a social networking platform to determine if the comments are relevant to the news story;
retrieving social content based on the comments determined to be relevant to the news story; and
providing the anchor story page for display, wherein the anchor story page comprises a plurality of links to news content items related to the news story, and at least a portion of the retrieved social content based on the comments determined to be relevant to the news story.

13. The computer-readable medium of claim 12, further comprising:
filtering the comments determined to be relevant to the news story,
wherein the social content is retrieved based on the filtered comments.

14. The computer-readable medium of claim 12, wherein retrieving social content based on the comments determined to be relevant to the news story comprises retrieving images associated with the comments.

15. The computer-readable medium of claim 12, wherein retrieving social content based on the comments determined to be relevant to the news story comprises retrieving links to content items associated with the comments.

16. A computer-implemented system comprising:
one or more processors; and
a memory storing instructions which, when executed by the one or more processors, cause the one or more processors to:
receive a request from a user for an aggregated content page related to a topic of interest;
retrieve comments related to the topic of interest from a social networking platform; and
provide the aggregated content page for display, wherein the aggregated content page includes a plurality of content items related to the topic of interest, and at least a portion of the retrieved comments related to the topic of interest.

17. The system of claim 16, further comprising instructions that cause the one or more processors to:
retrieve social content associated with the comments related to the topic of interest; and
provide at least a portion of the retrieved social content for display in the aggregated content page.

18. The system of claim 16, wherein retrieving comments related to the topic of interest comprises searching comments of the social networking platform for keywords related to the topic of interest and retrieving those comments that contain one or more of the keywords related to the topic of interest.

19. The system of claim 18, further comprising instructions that cause the one or more processors to:
filter the searched comments by a source of the comments, wherein at least a portion of the filtered comments are included in the aggregated content page.

20. The system of claim 18, further comprising instructions that cause the one or more processors to:
filter the searched comments by a time received of the comments, wherein at least a portion of the filtered comments are included in the aggregated content page.
